(19) United States
(12) Patent Application Publication
(10) Pub. No.: US 2004/0164263 A1
(43) Pub. Date: Aug. 26, 2004

(54) Fluids valve of high simplicity in connecting conduits

(76) Inventor: Renato Colombo, Borgomanero (IT)

Correspondence Address: RYAN KROMHOLZ & MANION, S.C., POST OFFICE BOX 26618, MILWAUKEE, WI, 53226, US

(21) Appl. No.: 10/728,716

(22) Filed: Dec. 5, 2003

(30) Foreign Application Priority Data
Dec. 6, 2002 (IT) MI2002A002599

(51) Int. Cl. F16L 29/00

(52) U.S. Cl. 251/148

(57) ABSTRACT

A fluid valve of high simplicity in connecting conduits to the input and/or output is disclosed. The valve includes of a body with at least one opening for the input and one for the output. With regards to at least one of the aforementioned openings, the valve is provided with a pipe coupling as an integral part of the body of the valve, which is inserted into a malleable sleeve capable of receiving a portion of the extremity of a tubular conduit. The malleable sleeve can conform around the valve tubular coupling as well as around the tubular conduit in entrance and exit to join the tubular conduit to the inlet or outlet of the valve body.

### RELATED APPLICATION

This application claims the benefit of co-pending Italian Patent Application No. MI2002A002599, filed 6 Dec. 2002.

### FIELD OF THE INVENTION

The present invention pertains to a fluid valve of high simplicity in connecting conduits for the input and/or output. The valve is comprised of a body with at least one opening for the input and one for the output. With regards to at least one of the aforementioned openings, the valve is provided with a pipe coupling as an integral part of the body of the valve, which is inserted into a malleable sleeve capable of receiving a portion of the extremity of a tubular conduit for the in/or/out outlet. The malleable sleeve can conform around the valve tubular coupling as well as around the tubular conduit in entrance and exit to join the tubular conduit to the inlet or outlet of the valve body.

### BACKGROUND OF THE INVENTION

The object of this invention is a valve of high simplicity in connecting the conduits thereof for the input and/or output of fluids.

As commonly known, the connection of fluid valves to an in/and/or/out conduit is achieved with threaded couplings, particularly for small or medium size valves.

In the last few years, with regards to joining metal, synthetic and multi-layer tubes, it has become more popular to use a connecting system based on the use of metal malleable sleeves, placed over the extremities of two tubes to be joined with the aid of a special crimping tool. The sleeve will so adhere to the two tubes and form a connection.

These sleeves generally have an inside washer or gasket for each tube to be connected, which binds to the outside surface of the tube, to assure a water-tight connection of the tubes. The malleability of the sleeve, which partially involves the tubes also, assures the mechanical connection of the tubes.

These connecting systems are able to guarantee a high level of dependability as long as a specific crimping tool for a particular type of sleeve is used. On the whole, in today's marketplace there are various joining systems of this kind, which differentiate among themselves by the type of the sleeve or the crimping tool used. The maximum level of reliability in joining each sleeve is achieved by using its specific crimping tool.

To use these types of connecting systems to join the in/and/or/out conduits to the valves, specific malleable sleeves were created, which are connected with one of their extremities to the body of the valve, corresponding to the in/out opening in the body of the valve.

In some instances, these sleeves are joined to the body of the valve, in the corresponding in/out opening, by a welding or soldering method. This solution, even though it guarantees a high degree of holding strength between the sleeve and the body of the valve, has the inconvenience of forcing the installer to use a specific crimping tool capable of handling the sleeve assembled to the body of the valve by the manufacturer. If the installer uses a different type of crimping tool, not specifically designed for the sleeve assembled to the valve, there would not be a reliable safety warranty in the connection of the sleeve with the in/out tube.

In other cases, there is the use of sleeves with a threaded end on one of their extremities, to be coupled with the corresponding threaded housing in the in/out opening of the valve. In this instance you would not encounter the aforementioned problems. Since the installer selects the threaded sleeve, it can be of the type suitable to be handled with the crimping tool used by the installer. This scenario, though, would diminish the reliability of the valve connection to the sleeve, since it relies on the installer. Its reliability is inevitably related to the installer's expertise, the condition under which he operates and other parameters hard to foresee.

On the other hand, if the valve manufacturer performs the assembly of the threaded sleeve to the body of the valve, there would be a higher degree of dependability in the connection of the sleeve to the body of the valve. There could be the same problem, though, with regards to the sleeve soldered to the body of the valve.

### SUMMARY OF THE INVENTION

The main purpose of the present invention is to solve the problems stated above, by producing a fluid valve that does not tie the installer to a particular connecting system for malleable sleeves. It offers an adequate guarantee of dependability with regards to the body connection of the valve to the in/and/or/out conduit.

In this scenario, the purpose of this invention is to produce a valve that, with complete freedom on the type of sleeve used, the installer can employ the connecting system of malleable sleeves that he normally uses. This would allow him optimum operating conditions and best results.

Another purpose of this invention is to create a valve that can be produced at a cost comparable to valves currently in the marketplace.

This function, and other objectives that will appear more clearly later, are reached with a fluid valve comprised of a valve body with at least one opening for inlet and one for outlet. Featuring, with regards to at least one of the openings, a tubular coupling connected to the body of the valve, which can be inserted into a sleeve capable of receiving a piece of the extremity of an in/and/or/out tubular conduit. Said sleeve is plastically molded around said tubular coupling and said in/and/or/out tubular conduit, in order to form a connection of said conduit to the body of the valve.

Further characteristics and advantages of the finding will appear more clearly in the description of the specific execution (although not exclusive) of the valve.

### BRIEF DESCRIPTION OF THE DRAWINGS

FIG. 1 shows a perspective view of the valve, according to the finding.

FIG. 2 shows the valve, according to the finding, in lateral elevation and partially sectioned, next to an in/and/or/out tubular conduit, to which it will be connected.

FIG. 3 shows a valve, according to the finding, assembled to an in/and/or/out conduit.

FIG. 4 shows a variation of execution of the valve, according to the finding, in a side view and partially sectioned.

FIG. 5 is a flow chart of the valve coupling annealing method.

### DESCRIPTION OF THE PREFERRED EMBODIMENT

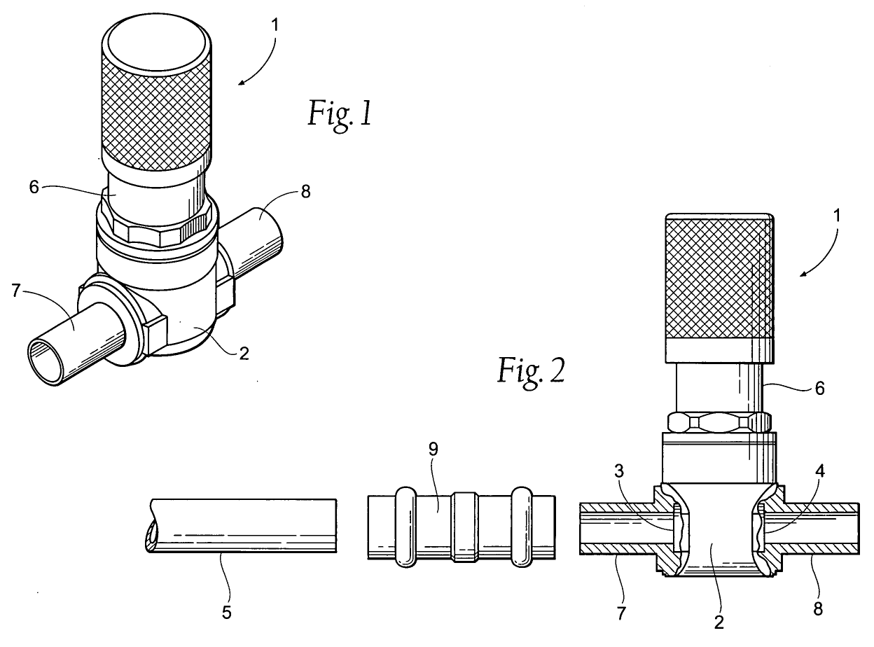

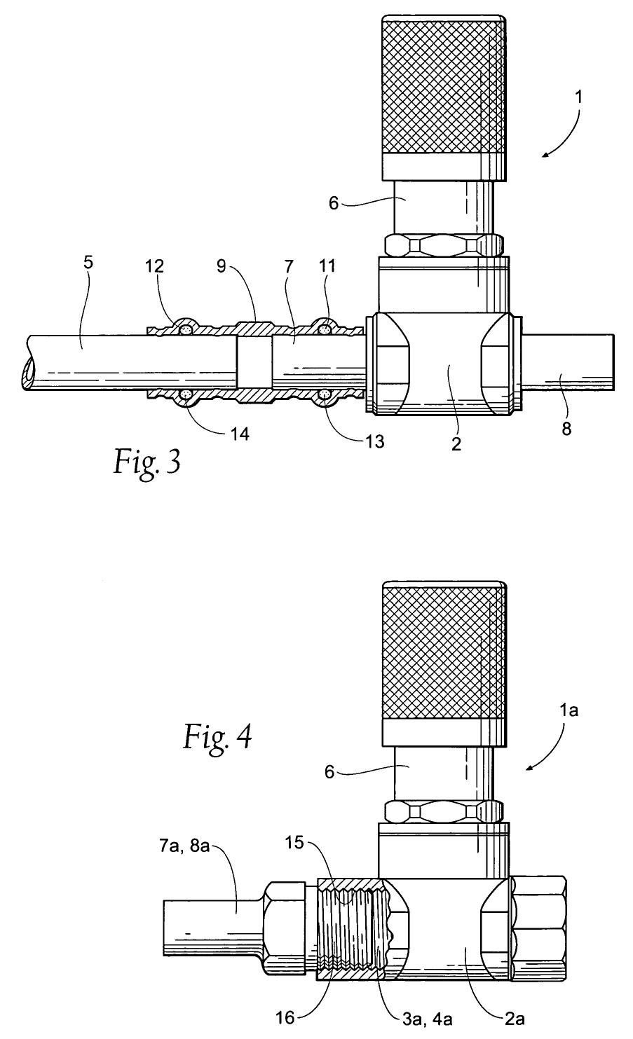

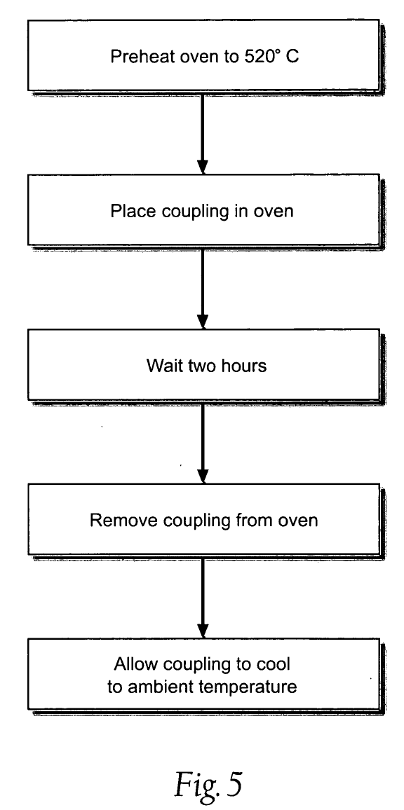

With regards to FIGS. 1 to 3, the valve in the finding, in its entirety referred to as number (1), comprises of a body of the valve (2), which shows at least one inlet opening (3) and one outlet (4) opening. They are intended to be connected to a respective inlet tubular conduit (5) and an outlet tubular conduit, not shown for simplicity reasons.

The body of the valve (2) can be made of one piece, or multiple assembled elements. The valve (1) has a flow control mechanism (6) capable of regulating the flow of fluid through the valve body (2). Such flow control mechanisms are well known in the art. Not by way of limitation and for example only, the preferred flow control mechanism (6) is a ball valve and in particular, a top entry ball valve. Top entry ball valves can be serviced by simply removing the ball valve from the valve body (2). Unlike other valve designs, it is not necessary to remove or sever the valve body from the conduits (5) when performing service. Another example of a preferred flow control mechanism is (6) is a sprinkler head valve having a valve body (2).

In reality, the material used to form the valve body (2) can be of any kind, as long as it is compatible with the specific use and the dimensions, according to need and technical condition. The valve body (2) is preferably fabricated from brass and specifically CW602N brass from the ADZ brass family. The ADZ brass family does not release or leave zinc when it is in contact with water. The main feature, which makes ADZ brass “dezincificating”, is the total absence of a metallurgical beta phase when the temperature of the brass exceeds 800 degrees Centigrade. In the preferred manufacturing process, the valve body (2) is formed by a hot pressing process during which the brass stock is mechanically swaged to form the valve body (2).

According to the invention, with regards to the in/and/or/out opening, the valve has a tubular coupling (7)(8), connected to the body of the valve (2), which protrudes from the body of the valve (2) The tubular coupling (7)(8) can be inserted into the sleeve (9), which is capable of receiving also part of the extremities of an in/and/or/out conduit cable (5). In a preferred embodiment, tubular couplings (7)(8) are annealed to stabilize the coupling material, make the coupling more malleable and prevent the formation of cracks in the coupling during the crimping or molding process described hereafter. The preferred annealing process is accomplished by placing the valve body (2) and tubular coupling (7)(8) assembly in an oven at 520 degrees Celsius for two hours. The valve body (2) and tubular coupling (7)(8) are then allowed to cool in an ambient temperature environment. While this is the preferred annealing process, it is to be understood that other annealing processes could be used on the assembly to achieve the same goals and still fall within the inventive scope of the present finding. In addition, the annealing process can be applied to the tubular couplings (7)(8) only.

For simplicity reason, the drawing shows only one tubular conduit, appearing as a tubular inlet and denoted with the number (5), which is meant to be connected to the coupling (7). Seemingly, the coupling (8) is meant to be connected the same way to a respective tubular conduit, known as outlet tubular conduit.

The entrance and the exit of the valve in question can be interchangeable.

The malleable sleeve (9) can be deformed with the use of an appropriate crimping tool, not shown for simplicity reason, which is normally used in connecting metal tubes.

More specifically, the sleeve (9) is made of metal and shows two circular seats (11)(12), at the two corresponding outlets, which houses two seals (13)(14). These two seats have the specific function of gripping and holding the outside surface of the tubular conduit (5) and the tubular coupling (7), inserted inside the sleeve (9).

The sleeve (9) can have a straight configuration conforming with the straight valve tubular connection and the straight conduit, therefore, providing an inline connection. The sleeve (9) can also have an elbow configuration or other standard configurations.

Preferably, the body of the valve (2) has a tubular coupling (7)(8) corresponding to each of its in/and/or/out opening.

As shown in FIGS. 1 to 3, the tubular couplings (7)(8) are preferably made of a single construction integrated in the valve body (2), or with the element of the body (2) where the in/and/or/out opening (3)(4) are left to be defined.

It is possible that the union of said tubular coupling with the body of the valve, or the element of the body of the valve in which the corresponding in/and/or/out opening is defined, is performed in other ways. For instance, through threaded couplings, as shown in FIG. 4, in which the tubular couplings are marked with reference numbers (7a)(8a). In said case, the body of the valve, marked with the reference number (2a), is shown with a threaded housing (15), in relation to the inlet opening (3a) and the outlet opening (4a). The housing is joined with the threaded end (16) to the matching tubular coupling (7a)(8a).

As an alternative, the tubular couplings, which connect with the in/out tubular conduits, can be joined to the body of the valve, or an element of the body of the valve, by welding, soldering or any other known joining technique.

The tubular couplings have a standard diameter, at least with regard to the portion to be inserted in the sleeve (9), so it can be correctly coupled with sleeves (9) currently available in the market place. In a preferred embodiment, the inner diameter of the tubular coupling is substantially the same as the inner diameter of the conduit and the outer diameter of the tubular coupling is substantially the same as the outer diameter of the tubular coupling.

The use of the valve according to the invention is as follows.

The valve manufacturer furnishes the valves with the tubular couplings (7)(8)(7a)(8a). In this manner, an utmost guarantee of safety is achieved with regard to joining the tubular couplings (7)(8)(7a)(8a) to the body of the valves (2)(2a).

In this matter, the installer can use the sleeves (9) of the connecting systems selected by the installer and for which he owns the corresponding crimping tool.

The connection of the valve's body to the tubular conduit (5) for the inlet or the outlet is performed by the installer in the same manner in which he joins two tubes through a sleeve (9).

More specifically, said connection is achieved by inserting the tubular coupling (7)(8)(7a)(8a) through one extremity of the sleeve (9) and by inserting a piece of the in/or/out tubular conduit (5) on the other extremity of the sleeve (9).

Subsequently, the installer, with the use of the proper crimping tool, proceeds to properly deform/mold part of the sleeve (9) around the tubular conduit (7)(8)(7a)(8a) and around the piece of the conduit inserted in the in/and/or/out outlet (5) completing in the manner the connection of the in/and/or/out tubular conduits to the body of the valve.

In actual testing, it was noted that the valve, according to actual findings, thoroughly achieves the pre-established objective. By allowing the use of any type of malleable sleeves to connect the in/and/or/out coupling, the installer can make use of any kind of connecting system that he already employs and for which he owns the necessary tooling. This allows the installer to do a better job and obtain the best results.

Moreover, the installation time is considerably reduced, by eliminating the step of connecting the coupling through a screwing process.

The valve, so conceived, is capable of multiple variations and changes, all within this inventive concept. Moreover, all the elements can be replaced with other technically equivalent components.

What is claimed is:

1. A valve to be connected to a conduit utilizing a malleable sleeve, said valve comprising:
a valve body having an inlet and an outlet formed therein;
a first coupling attached at said inlet;
a second coupling attached at said outlet; and
at least one of said couplings sized to be received within said malleable sleeve.

2. The valve of claim 1 wherein the first and second couplings are of integral, one-piece construction with the valve body.

3. The valve of claim 1 wherein the first and second couplings are welded to the valve body.

4. The valve of claim 1 wherein the first and second couplings are threaded to the valve body.

5. The valve of claim 1 wherein the valve body further includes a flow control mechanism.

6. The valve of claim 5 wherein the flow control mechanism is a ball valve.

7. The valve of claim 6 wherein the ball valve is a top entry ball valve.

8. The valve of claim 1 wherein said first and second couplings have an outer diameter that is substantially equivalent to an outer diameter of said conduit.

9. The valve of claim 1 wherein said first and second couplings have an inner diameter that is substantially equivalent to an inner diameter of said conduit.

10. The valve of claim 1 wherein at least one of said first and second couplings is annealed.

11. The valve of claim 1 wherein said valve body and at least one of said first and second couplings are annealed.

12. A valve body to be connected to a conduit with a malleable sleeve for controlling the flow of fluids there through, the valve body comprising:
an inlet and an outlet formed in the valve body;
a first coupling integrally formed with the valve body at the inlet;
a second coupling integrally formed with the valve body at the outlet; and
at least one of said couplings sized to receive said malleable sleeve.

13. The valve body of claim 12 further including a flow control mechanism located therein.

14. The valve body of claim 13 wherein the flow control mechanism is a ball valve.

15. The valve body of claim 14 wherein the ball valve is a top entry ball valve.

16. The valve body of claim 12 wherein said first and second couplings have an outer diameter that is substantially equivalent to an outer diameter of said conduit.

17. The valve body of claim 12 wherein said first and second couplings have an inner diameter that is substantially equivalent to an inner diameter of said conduit.

18. The valve body of claim 12 wherein at least one said first and second couplings is annealed.

19. The valve body of claim 12 wherein said valve body and at least one of said first and second couplings are annealed.

20. A valve for the interception of fluids comprising:
a valve body with at least one opening for an input and one opening for an output;
a first tubular coupling attached to the body at said inlet and a second tubular coupling attached to the body at the outlet;
at least one of said tubular couplings sized to be inserted into a sleeve capable of receiving a tubular conduit;
said sleeve being malleable around the selected one of said tubular couplings and around said tubular conduit to form a connection of the tubular conduit with the valve body.

21. The valve of claim 20 wherein the first and second tubular couplings are integrally formed with the valve body.

22. The valve of claim 20 wherein the valve body further includes a flow control mechanism.

23. The valve of claim 22 wherein the flow control mechanism is a ball valve.

24. The valve of claim 23 wherein the ball valve is a top entry ball valve.

25. The valve of claim 20 wherein said first and second couplings have an outer diameter that is substantially equivalent to an outer diameter of said conduit.

26. The valve of claim 20 wherein said first and second couplings have an inner diameter that is substantially equivalent to an inner diameter of said conduit.

27. The valve of claim 20 wherein at least one of said first and second couplings is annealed.

28. The valve of claim 20 wherein said valve body and at least one of said first and second couplings are annealed.

29. A method for annealing at least one coupling of a valve body to be connected to a conduit with a malleable sleeve for controlling the flow of fluids there through, the valve body having an inlet and an outlet formed in the valve body, a first coupling integrally formed with the valve body at the inlet, and a second coupling integrally formed with the valve body at the outlet, the method comprising the steps of:
placing at least one of said couplings into an oven heated to a predetermined temperature;
removing said coupling from said oven after a predetermined time period; and
allowing said coupling to cool.

30. The method of claim 29 wherein the predetermined temperature is substantially 520 degrees Celsius.

31. The method of claim 29 wherein the predetermine time is substantially two hours.

32. The method of claim 29 wherein the predetermined temperature is substantially 520 degrees Celsius and the predetermined time is substantially two hours.
